(19) United States
(12) Patent Application Publication
(10) Pub. No.: US 2025/0376278 A1
(43) Pub. Date: Dec. 11, 2025

(54) ELECTRONIC PAPER DISPLAY SYSTEM AND METHOD FOR EQUIPMENT SURFACE

(71) Applicant: E Ink Holdings Inc., HSINCHU (TW)

(72) Inventors: Pin-Cheng CHIU, HSINCHU (TW); Shu-Cheng LIU, HSINCHU (TW); Hsiao-Lung CHENG, HSINCHU (TW)

(21) Appl. No.: 19/228,775

(22) Filed: Jun. 5, 2025

(30) Foreign Application Priority Data
Jun. 11, 2024 (TW) 113121542

(51) Int. Cl. B64U 20/83; B64U 101/31; G02F 1/167; G02F 1/1685; G06T 7/90; G09G 3/34; H04N 23/84

(52) U.S. Cl. CPC B64U 20/83; G02F 1/1685; G06T 7/90; G09G 3/344; H04N 23/84; B64U 2101/31; G02F 1/167; G06T 2207/10024; G06T 2207/20084; G09G 2380/12

(57) ABSTRACT

The disclosure provides an electronic paper display system for equipment surface. The electronic paper display system includes an electronic paper display panel, an image capturing device, and a processor. The electronic paper display panel conformally covers the surface of equipment and is configured to display at least one color. The image capturing device is configured to capture the environment at which the equipment is located for generating an ambient image. The processor is electrically connected to the image capturing device and the electronic paper display panel and generates a control signal according to the ambient image. The electronic paper display panel changes the at least one color displayed on the surface of the equipment to be similar to an ambient color of the environment at which the equipment is located according to the control signal.

### RELATED APPLICATIONS

This application claims priority to Taiwan Application Serial Number 113121542, filed Jun. 11, 2024, which is herein incorporated by reference.

### BACKGROUND

### Technical Field

The disclosure relates to a display system and a method thereof, and more particularly relates to an electronic paper display system for equipment surface and an electronic paper display method thereof.

### Description of Related Art

In observing biological environments, observation equipment can easily be detected and even attacked by living creatures if it lacks concealment capabilities. If an observer is carried inside the observation equipment, the risk to the life of the observer is increased. Additionally, the lack of concealment may increase the consumption of resources, such as the need for additional rescue operations when the life of the observer is threatened.

### SUMMARY

Therefore, the disclosure provides an electronic paper display system for a surface of equipment. The electronic paper display system includes an electronic paper display panel, an image capturing device, and a processor. The electronic paper display panel conformally covers the surface of the equipment and is configured to display at least one color. The image capturing device is configured to capture the environment at which the equipment is located for generating an ambient image. The processor is electrically connected to the image capturing device and the electronic paper display panel, and generates a first control signal according to the ambient image for the electronic paper display panel to change the at least one color displayed on the surface of the equipment to be similar to an ambient color of the environment at which the equipment is located according to the first control signal.

According to an embodiment of the disclosure, the processor is further configured to train an artificial intelligence model through a color recognition algorithm, enabling the artificial intelligence model to recognize the ambient color of the ambient image and generate the first control signal corresponding to the ambient color.

According to an embodiment of the disclosure, the electronic paper display panel changes a pattern displayed on the surface of the equipment to be similar to an object outline of the environment at which the equipment is located according to the first control signal.

According to an embodiment of the disclosure, the color recognition algorithm includes Neural Networks, Region-based Color Analysis, and Color Difference Calculation.

According to an embodiment of the disclosure, the electronic paper display further includes a driving circuit. The driving circuit is electrically connected between the processor and the electronic paper display panel and is configured to generate a driving signal according to the first control signal for driving the electronic paper display panel to display the at least one color similar to the ambient color.

According to an embodiment of the disclosure, the electronic paper display panel includes display areas distributed on the surface of the equipment, and the processor is further configured to generate second control signals corresponding to the display areas according to the ambient image for each display area to display the at least one color to be similar to an adjacent ambient color according to the second control signals.

According to an embodiment of the disclosure, the image capturing device is a rotatable image capturing device, and is configured to capture several ambient images of the environment surrounding the equipment.

According to an embodiment of the disclosure, the electronic paper display system further includes a power supply system. The power supply system is configured to provide power required by the electronic paper display panel, the image capturing device, and the processor.

According to an embodiment of the disclosure, the electronic paper display panel is a segmented display including segments.

The disclosure provides an electronic paper display method applied on a surface of equipment. The surface of the equipment is covered with an electronic paper display panel for displaying at least one color. The electronic paper display method includes obtaining an ambient image of an environment where the equipment is located; training an artificial intelligence model through a color recognition algorithm for recognizing the ambient image to generate a first control signal corresponding to an ambient color of the environment where the equipment is located; and changing the at least one color displayed on the electronic paper display panel to be similar to the ambient color according to the first control signal.

According to an embodiment of the disclosure, the electronic paper display panel includes display areas distributed on the surface of the equipment, and the electronic paper display method further includes dividing the ambient image into several image blocks corresponding to the display areas; recognizing the image blocks in the ambient image through the artificial intelligence model to generate second control signals corresponding to the display areas; and adjusting the at least one color corresponding to these display areas to be similar to an adjacent ambient color according to the second control signals.

According to an embodiment of the disclosure, the electronic paper display method further includes adjusting patterns displayed on these display areas to be similar to object outlines of the environment at which the equipment is located according to the second control signals.

According to an embodiment of the disclosure, the electronic paper display method further includes capturing ambient images of the environment surrounding the equipment.

According to an embodiment of the disclosure, wherein the electronic paper display panel is a segmented display including segments.

According to an embodiment of the disclosure, the color recognition algorithm includes Neural Networks, Region-based Color Analysis, and Color Difference Calculation.

### BRIEF DESCRIPTION OF THE DRAWINGS

In order to make the above and other features, advantages and embodiments of the disclosure easier to understand, the accompanying drawings are described as follows.

FIG. 1 is a schematic diagram showing an electronic paper display system applied on a surface of equipment in accordance with an embodiment of the present disclosure.

FIG. 2 is a schematic diagram showing an electronic paper display method applied on a surface of equipment in accordance with an embodiment of the present disclosure.

### DETAILED DESCRIPTION

The following disclosure provides many different embodiments, or examples, for implementing different features of the provided subject matter. Embodiments of components and arrangements described below are merely examples and are not intended to be limiting. In addition, the present disclosure may repeat reference numerals and/or letters in the various examples for the purpose of simplicity and clarity and does not in itself dictate a relationship between the various embodiments and/or configurations discussed.

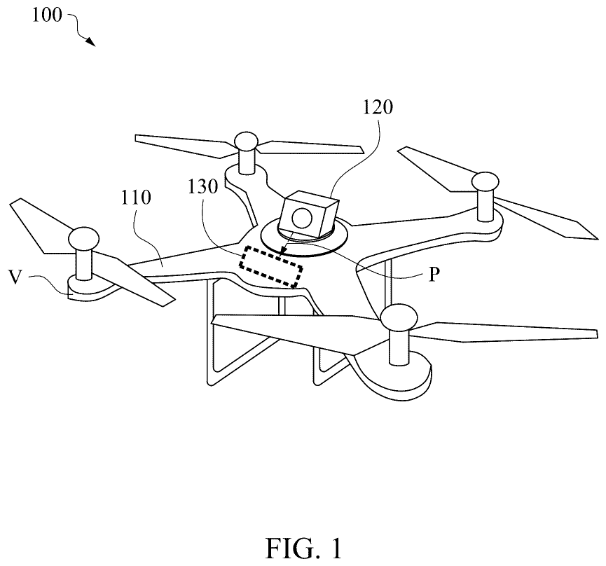

Reference is made to FIG. 1, which is a schematic diagram showing an electronic paper display system 100 in accordance with an embodiment of the present disclosure. The electronic paper display system 100 is applicable to any equipment surface, clothing, accessories, and mobile vehicles including but not limited to drones, cars, aircrafts, rescue equipment, precision shooting tools, or any equipment that requires visual concealment. In the example shown in FIG. 1, the electronic paper display system 100 is applied on the surface of equipment V (for example, on the surface of a drone) and includes an electronic paper display panel 110, an image capturing device 120, and a processor 130.

The electronic paper display panel 110 conformally covers the entire surface of the equipment V and is configured to display a desired color. The electronic paper display panel 110 has flexible and bendable characteristics for conforming to the appearance of the equipment V. In the example shown in FIG. 1, the electronic paper display panel 110 only covers the surface of the drone's main body. In other examples, the electronic paper display panel 110 may completely cover the entire drone, including, for example, additionally covering fan blades, support frames, and/or bearings of the drone.

In some embodiments, the electronic paper display panel 110 is composed of electronic ink applied to a thin-film transistor (TFT) substrate. Alternatively, the electronic paper display panel 110 may be a segmented display, and each segment corresponds to a driving line for driving the segments to form a desired pattern.

The image capturing device 120 is configured to capture an environment at which the equipment V is located for generating an ambient image P. The image capturing device 120 includes but is not limited to a digital camera, an Internet Protocol (IP) camera, an array optical coupling element (charge coupled device, CCD) camera, a complementary metal-oxide semiconductor (CMOS) camera, or other devices used for capturing videos or images.

In some embodiments, the image capturing device 120 is a rotatable image capturing device which may rotate to different orientations to capture the surrounding environment of the equipment V, and generate several ambient images P corresponding to these orientations. In some embodiments, the image capturing device 120 further includes long-range and close-range adjustment functions to obtain the ambient image P of the entire environment at which the equipment V is located.

It should be understood that, although the image capturing device 120 shown in FIG. 1 is illustrated on the main body of the drone, the image capturing device 120 may also be placed at other positions on the drone as needed without affecting the acquisition of the ambient image P. In other words, the image capturing device 120 is not limited to being placed on the main body of the drone.

The processor 130 is electrically connected to the image capturing device 120 and the electronic paper display panel 110, and is configured to receive the ambient image P captured by the image capturing device 120. The processor 130 may train an artificial intelligence model through a color recognition algorithm, so that the trained artificial intelligence model can automatically generate a control signal for controlling a color and a pattern displayed on the electronic paper display panel 110 based on the received ambient image P. In this way, the electronic paper display panel 110 may change the color displayed on the surface of the equipment V, and may further change the pattern displayed on the surface of the equipment V according to the control signal, so that the color and the pattern of the surface of the equipment V are similar to contours and colors of objects in the environment, thereby allowing the equipment V to be hidden in the surrounding environment.

In the above, reference to the color being “similar” indicates that grayscale values of the electronic paper display panel 110 are adjusted so that the displayed color can be as close as possible to the recognized ambient color. For example, the processor 130 recognizes the ambient color based on the ambient image P and selects the closest grayscale value (or within an acceptable range) to generate a control signal, so that the color displayed on the surface of the equipment V can be adjusted to be similar to the ambient color based on the control signal. Furthermore, the pattern displayed on the surface of the equipment V may also be adjusted for improving the concealment effect. For example, the equipment V may change its surface color to green and display leaf patterns on the surface when it is flying in a forest, or may change its surface color to brown and display tree bark patterns on the surface when resting on a branch to improve the concealment effect.

In the embodiment of the disclosure, the color recognition algorithm includes Neural Networks, Region-based Color Analysis, and Color Difference Calculation. By utilizing the color recognition algorithm, the processor 130 can automatically recognize the color in the ambient image P and calculate the corresponding control signal(s) to change the color displayed on the surface of the equipment V to be similar to the ambient color.

In the embodiment of the disclosure, the electronic paper display system 100 further includes a driving circuit (not shown). The driving circuit is electrically connected between the processor 130 and the electronic paper display panel 110 and is configured to generate a corresponding driving signal according to the control signal for driving the electronic paper display panel 110 to display the color similar to the ambient color.

In the embodiment of the disclosure, the electronic paper display system 100 further includes a power supply system (not shown). The power supply system is configured to provide DC power or AC power required by the electronic paper display panel 110, the image capturing device 120, and the processor 130.

In the embodiment of the disclosure, the processor 130 may be embedded into the equipment V to form a modular integrated circuit with the electronic paper display panel 110, the driving circuit and the power supply system, but the disclosure is not limited thereto. In the embodiments of the disclosure, the image capturing device 120 may automatically recognize the ambient color without communicating with a ground control station, and thereby allow for control to instantly change the appearance color of the equipment V based on the environment image P.

In some embodiments, the processor 130 is further configured to adjust shooting angles, orientations, reduction ratios of distant view, and/or magnification ratios of close view of the image capturing device 120. For example, in an embodiment in which the electronic paper display panel 110 includes multiple display areas, when the processor 130 cannot recognize the ambient colors corresponding to these display areas from the environment image P, a regulation signal is generated to adjust a shooting angle, an orientation, and/or a distance/close range magnification of the image capturing device 120 to regain one or more ambient images P that can be recognized.

In the embodiment of the disclosure, the electronic paper display panel 110 can be divided into multiple display areas to respectively cover different positions on the surface of the equipment V. Each display area may be independently controlled by the processor 130 to exhibit more subtle display colors. In such an embodiment, the processor 130 is further configured to generate multiple control signals corresponding to these display areas according to one or more ambient images P. Therefore, each display area can display color(s) similar to the adjacent ambient color(s) according to the corresponding control signal. Alternatively, each display area can display a pattern in accordance with a corresponding control signal, so that the pattern displayed on the surface of the equipment V at different positions is similar to contours of objects in the adjacent environment.

In the embodiment of the disclosure, the electronic paper display panel 110 includes a deformable substrate, a stretchable electrode layer, and a stretchable electrophoresis dielectric layer, which enables the electronic paper display panel 110 to be three-dimensionally molded onto the surface of the equipment V of different shapes.

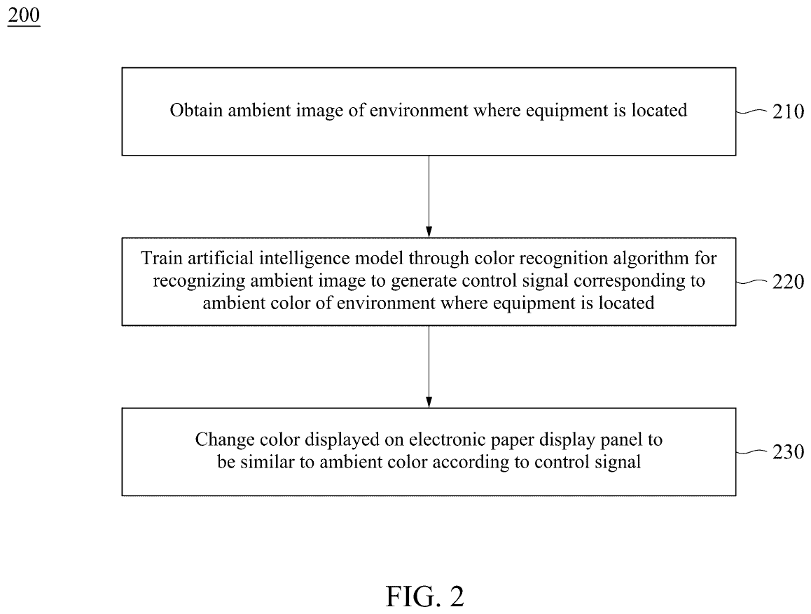

Reference is made to FIG. 2, which is a schematic diagram showing an electronic paper display method 200 applied on a surface of equipment V in accordance with an embodiment of the present disclosure. The electronic paper display method 200 includes steps 210 to 230. The electronic paper display method 200 may be implemented by the electronic paper display system 100 shown in FIG. 1 or by another similar configuration. The electronic paper display system 100 shown in FIG. 1 is taken as an example for the description below.

In step 210, the image capturing device 120 first obtains an ambient image P of an environment at which the equipment V is located. The image capturing device 120 may rotate to different orientations to capture the surrounding environment of the equipment V, thereby generating one or more ambient images P of the environment adjacent to the electronic paper display panel 110 on the equipment V.

In step 220, an artificial intelligence model trained with a color recognition algorithm recognizes the ambient image P to generate a control signal that corresponds to an ambient color of the environment at which the equipment V is located. Specifically, the step of training the artificial intelligence model through the color recognition algorithm further includes collecting several ambient images as a dataset for generating the artificial intelligence model that may recognize the ambient color of the environment based on the ambient image(s) P. The images as a dataset are such as outdoor images (sky, woods, beach, buildings, smoke color, etc.) or indoor images (wall, window, bracket color, etc.).

In step 230, the processor 130 transmits the control signal to the electronic paper display panel 110 for changing the color displayed on the electronic paper display panel 110 to be similar to the ambient color according to the control signal. In greater detail, a driving circuit is further included between the processor 130 and the electronic paper display panel 110. The processor 130 may transmit the control signal to the driving circuit for generating a corresponding driving signal, then the driving circuit drives one or more display areas of the electronic paper display panel 110 to display a corresponding color(s) based on the corresponding driving signal. As a result, the equipment V can be maximally concealed within the environment, making it less susceptible to detection.

According to the electronic paper display system applied on the surface of the equipment and the electronic paper display method thereof, the color of the equipment can be automatically adjusted according to the ambient color through the electronic paper display panel conformally shaped on the equipment and the color recognition algorithm, thereby achieving a good concealment effect. In summary, the present disclosure improves the environmental adaptability and survivability of the equipment, and reduces the risk of being detected or attacked.

Although the description provided above is of various embodiments of the disclosure, this is not intended to limit the scope of the disclosure. Those skilled in the art may make various modifications without departing from the spirit and scope of the disclosure. Therefore, the scope of protection of the present disclosure is determined by the following claims.

What is claimed is:

1. An electronic paper display system for a surface of equipment, comprising:
an electronic paper display panel conformally covering the surface of the equipment and configured to display at least one color;
an image capturing device configured to capture an environment at which the equipment is located for generating an ambient image; and
a processor electrically connected to the image capturing device and the electronic paper display panel, and generating a first control signal according to the ambient image for the electronic paper display panel to change the at least one color displayed on the surface of the equipment to be similar to an ambient color of the environment at which the equipment is located according to the first control signal.

2. The electronic paper display system of claim 1, wherein the processor is further configured to train an artificial intelligence model through a color recognition algorithm, enabling the artificial intelligence model to recognize the ambient color of the ambient image and generate the first control signal corresponding to the ambient color.

3. The electronic paper display system of claim 2, wherein the electronic paper display panel changes a pattern displayed on the surface of the equipment to be similar to an object outline of the environment at which the equipment is located according to the first control signal.

4. The electronic paper display system of claim 2, wherein the color recognition algorithm comprises Neural Networks, Region-based Color Analysis, and Color Difference Calculation.

5. The electronic paper display system of claim 1, further comprising:
a driving circuit electrically connected between the processor and the electronic paper display panel and configured to generate a driving signal according to the first control signal for driving the electronic paper display panel to display the at least one color similar to the ambient color.

6. The electronic paper display system of claim 1, wherein the electronic paper display panel comprises a plurality of display areas distributed on the surface of the equipment, and the processor is further configured to:
generate a plurality of second control signals corresponding to the plurality of display areas according to the ambient image for each of the plurality of display areas to display the at least one color to be similar to an adjacent ambient color according to the plurality of second control signals.

7. The electronic paper display system of claim 1, wherein the image capturing device is a rotatable image capturing device, and is configured to capture a plurality of ambient images of the environment surrounding the equipment.

8. The electronic paper display system of claim 1, further comprising:
a power supply system configured to provide power required by the electronic paper display panel, the image capturing device, and the processor.

9. The electronic paper display system of claim 1, wherein the electronic paper display panel is a segmented display comprising a plurality of segments.

10. An electronic paper display method applied on a surface of equipment, the surface of the equipment is covered with an electronic paper display panel for displaying at least one color, the electronic paper display method comprises:
obtaining an ambient image of an environment where the equipment is located;
training an artificial intelligence model through a color recognition algorithm for recognizing the ambient image to generate a first control signal corresponding to an ambient color of the environment where the equipment is located; and
changing the at least one color displayed on the electronic paper display panel to be similar to the ambient color according to the first control signal.

11. The electronic paper display method of claim 10, wherein the electronic paper display panel comprises a plurality of display areas distributed on the surface of the equipment, and the electronic paper display method further comprises:
dividing the ambient image into a plurality of image blocks corresponding to the plurality of display areas;
recognizing the plurality of image blocks in the ambient image through the artificial intelligence model to generate a plurality of second control signals corresponding to the plurality of display areas; and
adjusting the at least one color corresponding to the plurality of display areas to be similar to an adjacent ambient color according to the plurality of second control signals.

12. The electronic paper display method of claim 11, further comprising:
adjusting patterns displayed on the plurality of display areas to be similar to object outlines of the environment at which the equipment is located according to the plurality of second control signals.

13. The electronic paper display method of claim 10, wherein the color recognition algorithm includes Neural Networks, Region-based Color Analysis, and Color Difference Calculation.

14. The electronic paper display method of claim 10, further comprising:
capturing a plurality of ambient images of the environment surrounding the equipment.

15. The electronic paper display method of claim 10, wherein the electronic paper display panel is a segmented display comprising a plurality of segments.
